(19) United States
(12) Patent Application Publication
(10) Pub. No.: US 2017/0174305 A1
(43) Pub. Date: Jun. 22, 2017

(54) WATERCRAFT, IN PARTICULAR TUGBOAT

(71) Applicant: VOITH PATENT GMBH, HEIDENHEIM (DE)

(72) Inventors: DIRK JUERGENS, HEIDENHEIM (DE); MICHAEL PALM, HEIDENHEIM (DE); SEBASTIAN SINGER, HEIDENHEIM (DE)

(21) Appl. No.: 15/115,737

(22) PCT Filed: Jan. 30, 2015
(86) PCT No.: PCT/EP2015/051906

§ 371 Date: Aug. 1, 2016

(30) Foreign Application Priority Data
Jan. 31, 2014 (DE) 102014201745.9

(51) Int. Cl. B63H 21/21; G05D 1/02; B63H 25/42; B63B 21/16; B63B 21/56; B63B 35/68

(52) U.S. Cl. CPC B63H 21/21; B63B 21/56; B63B 35/68; B63H 25/42; B63B 21/16; G05D 1/0206; B63B 2021/566; B63B 2722/00; B63B 2723/00; B63H 2025/005

(57) ABSTRACT

A tugboat for assisting cargo vessels has the following features: at least one propelling unit and a tow line for establishing a pulling connection between the cargo vessel and the tugboat. A measuring device measures the bollard pull and a central processing unit records the measurement result and forms a control command relating to the propelling force and/or the propelling direction for propelling purposes.

The invention concerns a watercraft, in particular a tugboat with at least one drive and at least one tow line for making a pulling connection between a cargo vessel and the tugboat.

Tugboats for assisting cargo vessels are previously known in diverse embodiments. In this case it is in particular a tugboat with controllable drives. Cycloidal propellers of the Voith-Schneider® or azimuthal propeller type are used as drives for example. Other types of drive, such as conventional propellers and transverse rudders are also conceivable. Such tugboats are used for maneuvering and for escorting large cargo vessels, in particular tankers. For this the tugboats are joined to the cargo vessel by means of a tow line. For example, one end of the tow line passes around a bollard that is disposed on the cargo vessel for this. The other end passes round a winch that is generally disposed at the stern of the tugboat. In this case, a tow line means in particular a cable in the form of steel cable, vegetable fibers or synthetic material.

The bollard pull, i.e. the line force that can be transferred by means of the tow line, plays an important role in assisting. It should be as uniform as possible, and indeed regardless of the positions of the tugboat and the cargo vessel relative to each other, both when traveling forwards and backwards. The forces acting on the tow line are enormous and can vary significantly when maneuvering as well as when escorting. Here the bollard pull is not only determined by those forces that are applied by the drive of the tugboat. Rather, the bollard pull also depends on the ambient conditions, in particular the swell. Thus in the case of a high swell the bollard pull can rise to double the value that usually occurs when the tugboat is working. Such spikes in the strain are highly dangerous and can cause damage, for example pulling out the bollard on the cargo vessel or the winch on the tugboat.

In order to prevent such spikes in the strain in the tow line, so-called escort winches are used. Said escort winches have a strain damping effect. The disadvantage is in the very complex design and a significant cost increase compared to an ordinary winch. In this case the reduction of spikes in the strain is also not optimal with this. In the case of correspondingly high waves, high loads can also still act on the components involved in the pulling connection on the cargo vessel and on the tugboat, so that said components must additionally be suitably strongly dimensioned.

The object of the invention is therefore to minimize or to eliminate said problem of spikes in strain without requiring the use of expensive escort winches and over dimensioning of the components involved in the pulling connection.

This object is achieved according to the invention by the features according to claims 1 and 10. Advantageous configurations are described in the dependent claims.

A watercraft implemented according to the invention, in particular a tugboat for assisting cargo vessels, with at least one drive and at least one tow line for making a pulling connection between a cargo vessel and the tugboat, is characterized by the following features:
with at least one detecting device for at least indirectly detecting at least one variable characterizing the bollard pull;
with a control and/or regulating device that is coupled to the detecting device for detecting at least one variable at least indirectly characterizing the bollard pull and that is configured to form at least one control variable for activating at least one control device of the at least one drive for influencing the thrust force and/or the direction of thrust of the tugboat.

In a particularly preferred form, such a tugboat comprises
a measuring device for detecting the bollard pull
a central processing unit (CPU) for detecting the measurement result and for forming and forwarding a control command regarding the thrust force and/or direction of thrust to the drive.

A variable at least indirectly describing a determined variable means either the variable itself or else a variable having a functional or other defined relationship to said variable. Direct detection of the determined variable is then not absolutely necessary.

A bollard pull describes the force prevailing in the tow line or the line.

The solution according to the invention gives the advantage of responding rapidly to changes in the pulling connection that can lead to critical situations and of rapidly compensating changes by active adaptation of the orientation and of the motional behavior of the tugboat relative to the cargo vessel. The expensive escort winches are completely eliminated or would be at least minimized to very low power levels. The costs are reduced accordingly. The considerable weight of an escort winch is eliminated or is minimized.

In one design, the detecting device for the detection of at least one variable at least indirectly characterizing the bollard pull is designed as a device for the detection of a variable from the following group of variables:
force sensor
torque sensor
   and is disposed close to a cable device for guiding the tow line.

Said solution gives the advantage of drawing on detecting or measuring devices that are already present in the cable device, in particular the winch, and no additional costs for integrating the function within the tugboat.

The tugboat preferably comprises a target value specification device for specifying a target value for a bollard pull that is to be set. The control and/or regulating device forms or comprises a comparator that is designed to compare the target value and the actual value and a control variable generator that is designed and configured to form a control variable for activating a control device of the individual drive for changing the direction of thrust and/or the thrust force.

A target value specification device, comparator and control variable generator are not limited in respect of the design thereof to any specific implementation. In particular, the terms are to be interpreted here regarding the functions to be exerted. The functions can be executed by standalone components or within a program.

The control device of the drive means in particular the control device assigned to a type of drive, as a defined type of drive is characterized by the control device assigned thereto in each case.

In a particularly advantageous design, the individual drive is in the form of a cycloidal propeller, particularly preferably a Voith-Schneider propeller, and the tugboat particularly preferably comprises at least two drives in the form of Voith-Schneider propellers.

The control devices for the orientation of the propeller blades operate as possible control devices, for example.

Drive concepts with Voith-Schneider propellers are particularly suitable for tracking the target value of a bollard pull with the actual value rapidly and at low cost. In this case, where there is a plurality of drives, each drive is preferably actuated separately but with the drives matched to each other. Other embodiments are conceivable.

In a particularly advantageous development, the tugboat comprises at least one detecting device, which is coupled to the control and/or regulating device, for the detection of a variable describing a change of an ambient condition of the tugboat causing the bollard pull.

The detecting device for the detection of a variable describing a change of the ambient condition of the tugboat causing the bollard pull can in this case be in the form of a detecting device for the detection of a variable describing the motion of the tugboat or a detecting device for the detection of a variable describing the ambient conditions of the tugboat. In detail, the following designs are conceivable for this:
roll angle detecting device
course angle detecting device
course angle rate of change detecting device
course angle acceleration detecting device
roll angle acceleration detecting device
pitch angle (angle about the lateral axis of the ship)
pitch angle acceleration
wave height detecting device
wave frequency detecting device
wave direction detecting device.

For this use can be made of some of the detecting devices that are already necessary for drive control.

Furthermore, an analyzer is provided in the control and/or regulating device that derives the changing behavior of the actual value of the bollard pull against time under the influence of said variables from the aforementioned variables and provides a target-actual value comparison, so that not only is a response made to actual changes, but otherwise occurring changes can also be actively counteracted with a time lag.

A method according to the invention for regulating the bollard pull, in particular the line force in the pulling connection between a cargo vessel and a tugboat for assisting the same, wherein the tugboat comprises at least one drive, a tow line for making a pulling connection to the cargo vessel and a control and/or regulating device, is characterized

in that
according to a first regulation concept an actual value of a variable characterizing the bollard pull in the pulling connection is detected at least indirectly, and if the value exceeds a predefined target value and/or if it deviates from a predefined target value, the at least one drive for influencing the thrust force and/or the direction of thrust of the tugboat is activated,
and/or
according to a second regulation concept an actual value of a variable characterizing the bollard pull in the pulling connection is detected at least indirectly, a change of the actual value occurring with a time lag is determined and if the value exceeds a predefined target value and/or if it deviates from a predefined target value (exceeds or falls below), the at least one drive for influencing the thrust force and/or the direction of thrust of the tugboat is activated.

The first regulation concept enables active adaptation by a timely response to a deviation that arises between the actual value and the target value. The second regulation concept gives the advantage of responding in advance to the changes arising with a time lag and of inhibiting said changes or at least minimizing the change.

Both regulation concepts can be employed on their own for this, i.e. either only the first or second regulation concept can be used.

It is particularly advantageous, however, if the second regulation concept is overlaid with the first regulation concept. In this case, both the external influences that can lead to a change and also the factors that can influence the coupled together watercraft are adequately taken into account and a stable compliance with the desired target value for the bollard pull is ensured under all circumstances.

For the second regulation concept, in an advantageous development at least one of the variables mentioned below is detected:
a variable describing the motion of the tugboat at least indirectly
a variable describing the external ambient conditions of the tugboat at least indirectly, wherein the change of the actual value for the bollard pull occurring with a time lag is determined as a function of at least one of said variables or is derived from the same.

At least one variable selected from the following group of variables is preferably detected as a variable describing the motion of the tugboat at least indirectly:
roll angle
course angle
course angle rate
course angle acceleration
roll angle acceleration
pitch angle
pitch angle acceleration

The variables describing the motion of the tugboat are variables that are determined anyway for the control of the drives and are therefore available, whereby no additional expenditure is necessary for the regulation.

As a variable at least indirectly describing the external ambient conditions of the tugboat, at least one variable selected from the following group of variables is detected:
wave height
wave frequency
wave direction.

The drive is preferably a cycloidal propeller, preferably a Voith-Schneider propeller. There is indeed always a winch present, but not an escort winch of the type mentioned.

Owing to the great flexibility of the operation of such a drive, a rapid response can be made to suddenly occurring high wave forces.

The aforementioned possibilities give the advantage of detecting events or states in advance that cause a change of the bollard pull and actively opposing it. Thus the occurrence of large waves with correspondingly high forces can be detected in a particularly advantageous manner, and the measurement result forwarded to the CPU, which for its part issues corresponding control commands to the drive. The control command can consist of reducing or increasing the thrust force, or changing the direction of thrust with the aim of adjusting the orientation of the tugboat, for example changing the angle alpha. This is the angle between the central longitudinal axis of the tugboat and the central longitudinal axis of the cargo vessel, or the yaw angle of the tugboat.

In one development, the actual value of a variable at least indirectly characterizing the bollard pull in the pulling connection is detected by detecting at least one of the variables selected from the following group of variables:
pulling force or line force
torque on the winch of a cable device.

The detection of at least one of the following variables is carried out continuously in a particularly advantageous way
the actual value of a variable at least indirectly characterizing the bollard pull in the pulling connection;
   a variable at least indirectly describing the motion of the tugboat
   a variable at least indirectly describing the external ambient conditions of the tugboat.

The continuous detection enables very rapid responsiveness. However, detection in predefined, preferably short time intervals is also alternatively conceivable.

The target value for the individual regulation concepts can be predefined in a different way. It is conceivable for example to define the target value as a permissible maximum value for the line force that may not be exceeded or as a predefined average value for the line force that is to be achieved.

Additional functions can be integrated within the individual regulation concepts for this, for example permissible tolerance ranges, etc.

The individual regulation concepts are preferably executed within programs or routines in the control and/or regulating device.

The invention is described using the figures. In the figures, the following are illustrated in detail:

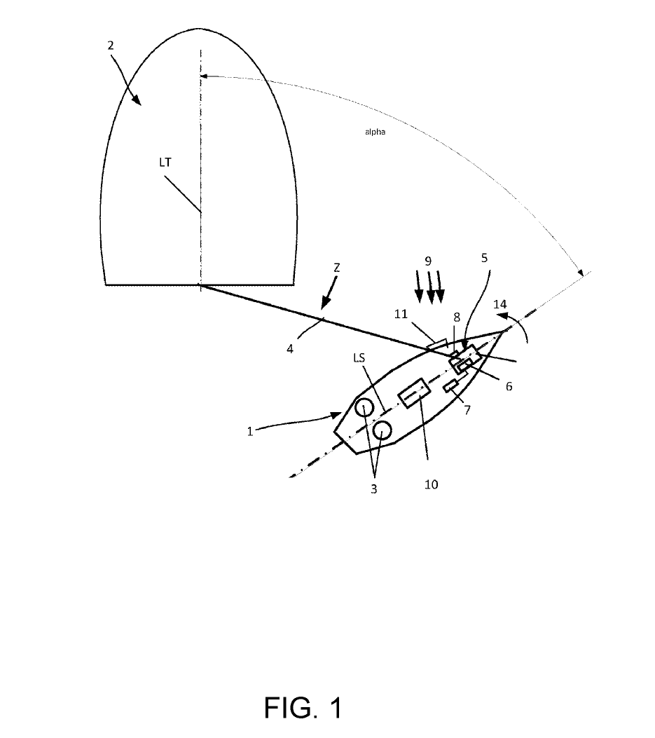

FIG. 1 shows by way of example an escort situation of a tugboat with a cargo vessel;

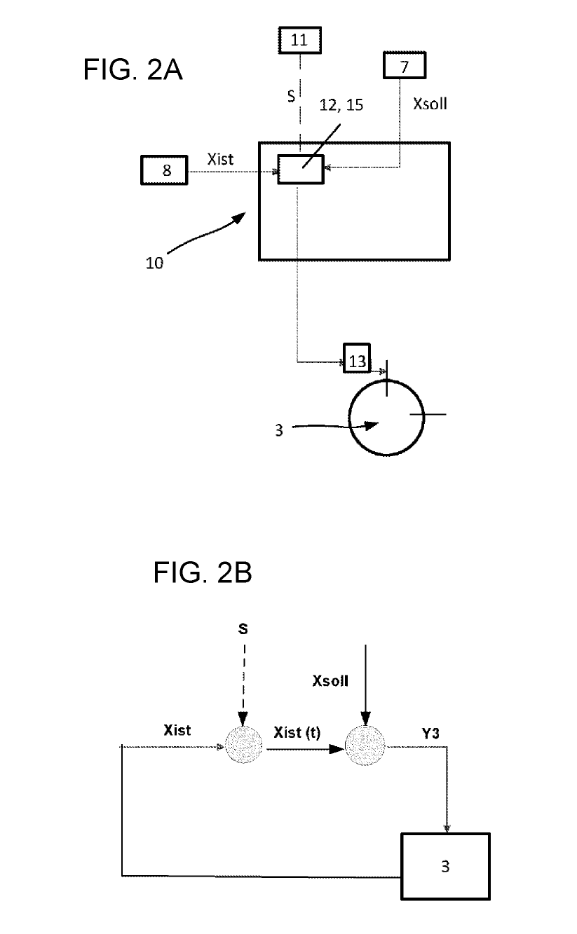

FIG. 2a illustrates in a schematic simplified representation the basic configuration of a control and/or regulating device;

FIG. 2b illustrates in a schematic simplified representation the advantageous overlaying of the first and second regulation concepts;

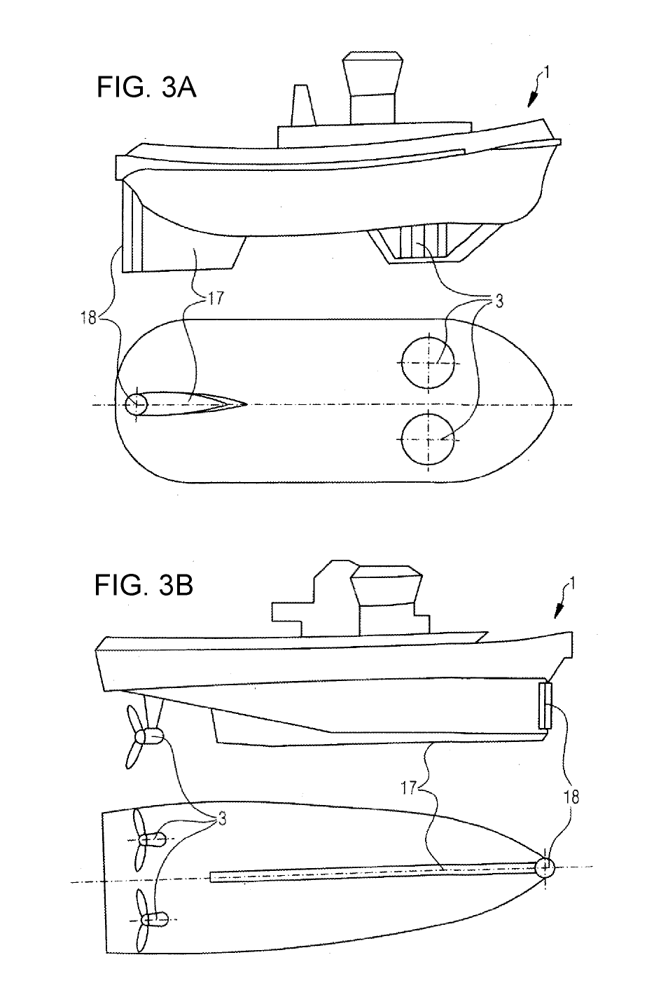

FIGS. 3a and 3b show by way of example embodiments of escort tugboats with controllable drives.

FIG. 1 illustrates in a schematic simplified representation and by way of example a tugboat 1 designed according to the invention for assisting or escorting cargo vessels 2, for example a tanker vessel. The outlines of the individual watercraft are only indicated schematically here. The tugboat 1 comprises at least one drive 3, here by way of example two drives 3. Said drives are in the form of Voith-Schneider propellers in a particularly advantageous design, and in the illustrated case are disposed symmetrically relative to a central longitudinal axis LS lying in the longitudinal direction of the tugboat 1. For assisting, a pulling connection Z is provided between the tugboat 1 and the cargo vessel 2. The pulling connection Z is implemented by means of a tow line 4. Such tow lines 4—also referred to as towing cables—are reeled on the tugboat 1 for example on winches or are hung on hooks. In the first case, the tugboat 1 comprises a suitable cable device 5 for this. Said cable device comprises by way of example at least one winch and a drive associated with the winch.

The force that can be transferred by means of the pulling connection Z between the tugboat 1 and the cargo vessel 2 is characterized by the connecting element that is implementing said force, in particular the tow line 4. The tow line 4 itself is configured for a certain predefined force to be transferred, which is also referred to as the line force regardless of the selected material of the tow line. The bollard pull present in the pulling connection Z is limited by the maximum permissible line force and the maximum permissible load on the attachment elements, in particular for attaching the bollard to the cargo vessel 2. Therefore, a target value specification Xₛₒₗₗ is carried out for the bollard pull on the tugboat 1 that is to be set in the pulling connection Z. Depending on the regulation concept and regulator version, the target value can be set as a permissible maximum value that may not be exceeded, and if the value is exceeded the drives 3 are activated such that the target value or a value below the target value is set. According to a second version, in the event of a deviation (exceeding or falling below) of the actual value Xᵢₛₜ from the target value Xₛₒₗₗ, the drive or the drives 3 is/are activated such that the target value Xₛₒₗₗ is set. In this case the target value preferably describes and corresponds to a predefined average value for the line force.

The target value specification for the bollard pull Xₛₒₗₗ is preferably carried out as a target value specification directly for the line force to be set or to be applied. It is also conceivable to describe said target value by means of a variable at least indirectly characterizing the bollard pull. In this case, such variables at least indirectly characterizing the bollard pull have a functional or direct relationship to the bollard pull.

The specification of a target value Xₛₒₗₗ of a bollard pull to be set or of a line force to be set is carried out for example by means of a target value specification device 7, which can be implemented in various ways.

A defined length of the tow line 4 is provided on the cable device 5 itself by means of a control device 6 in the event of a pulling connection request. In FIG. 1, the cargo vessel 2 and the tugboat 1 are suitably positioned relative to each other. The two central longitudinal axes LS of the tugboat 1 and LT of the cargo vessel are oriented at an angle alpha relative to each other in the illustrated position.

The angle alpha corresponds in this case to the yaw angle of the tugboat 1.

External forces act on the tugboat 1, in particular wind and wave forces of considerable magnitude, which would temporarily massively increase the pull acting on the tow line 4 without countermeasures. This is prevented according to the invention by turning the tugboat 1 by acting on the drives 3, 3 in the sense of the arrow 14. According to the invention, an actual value Xᵢₛₜ of a variable at least indirectly characterizing the bollard pull is detected preferably continuously or at predefined time intervals for this and is compared with the target value Xₛₒₗₗ. In the event of a deviation of the actual value Xᵢₛₜ from the target value Xₛₒₗₗ, at least one control device 13 of the individual drive 3 is activated. At least one detecting device 8 for an actual value Xᵢₛₜ of a variable at least indirectly characterizing the bollard pull Xᵢₛₜ is provided for this. The detection of the bollard pull is preferably carried out directly and the detecting device is in the form of a detecting device for the currently existing line force. It is also conceivable to determine the actual value of the line force not directly but by means of the detection of the actual values of other variables that have a direct or functional relationship to the line force, wherein the actual value Xᵢₛₜ is then formed from said variables.

The detecting device 8 is preferably disposed in or on the cable device 5. In the simplest case, the devices that are provided anyway for measuring the line force in the winch are used for this.

For the comparison of the actual value Xᵢₛₜ with the target value Xₛₒₗₗ and for activating the individual drives 3, the control and/or regulating device 10 is configured and designed to carry out the functions of the comparison and the generation of the control variable. Said control and/or regulating device 10 comprises for example a comparator 12 and a control variable generator 15, which forms the control variable Y₃ for activating the control device/control devices 13 of an individual drive 3 using the determined deviation ΔX between the target value and the actual value.

According to the basic configuration of the regulator and hence a first regulation concept, an active correction is only carried out if there is a deviation ΔX.

According to a particularly advantageous development, it is however provided to respond predictively to the factors influencing the line force. For this purpose, for a second regulation concept preferably overlaying the first regulation concept, the external variables causing a change in the behavior of the bollard pull, in particular an external variable at least indirectly influencing the motion of the tugboat 1, such as for example the swell, are detected in terms of the height and/or direction thereof. The external variables at least indirectly influencing the motion of the tugboat are variables selected from the group of variables mentioned below:
the variables directly describing the motion of the tugboat 1, such as for example at least one of the variables mentioned below
roll angle
course angle
course angle rate of change
course angle acceleration
roll angle acceleration
pitch angle
pitch angle rate
   or variables with a functional or direct relationship thereto, such as wave frequency, wave height and wave direction. Said variables are fed as input signals to the control and/or regulating device 10. In said control and/or regulating device 10, a control variable Y₃ for activating the individual drive 3 is formed from said input signals. Said control signal is for example for a change in the pitch of the propeller and/or a change in the revolution rate and/or a change in the azimuth angle.

It is understood that all input and output variables can be signals that can be transmitted in different ways. The individual detecting devices 8 and 11 are coupled to the control and/or regulating device 10 for communications for this purpose. The coupling can be carried out directly, i.e. by means of line connections, or wirelessly. This also applies by analogy to the control devices 13 and 6.

Sensors are used as detecting devices 8 and/or 10 for example. Acceleration sensors and wave wheel sensors are used as detecting devices.

The control and/or regulating device 10 can for example be implemented as a central control unit or even as a distributed control unit, wherein the individual components are coupled together by means of a bus. In one case the control and/or regulating device 10 may only be used for the functions of setting a bollard pull and can be subordinate to or associated with a central control and/or regulating device of the tugboat 1. In the other case, the functions of the control and/or regulating device 10 are undertaken by the central control and/or regulating device for the control of the tugboat 1, i.e. the central control and/or regulating device of the tugboat forms the control and/or regulating device 10.

FIG. 2a illustrates in a schematic simplified representation the control and/or regulating device 10 and the input and output variables as well as couplings of the same to the individual components. The detecting device 8 for the detection of at least one variable at least indirectly characterizing the bollard pull and the target value specification device 7 for specifying a target value Xₛₒₗₗ for the bollard pull can be seen. Said devices are coupled to the control and/or regulating device 10, in particular a central processing unit, in particular to the inputs thereof. Said control and/or regulating device 10 is preferably the control device for the drive 3 that is present anyway, in particular the controller of the Voith-Schneider propeller for the implementation according to FIG. 1.

The control variables Y₃ for activating the drives 3 in the event of a deviation between the target value and the actual value of the bollard pull are formed by means of said central processing unit and the respective control devices 13 thereof are activated.

The variables S provided by means of the detecting device 11 are processed in an analyzer that is not illustrated here or within the control and/or regulating device 10 and the theoretical changing behavior of the actual value Xᵢₛₜ(t) of the bollard pull against time is derived therefrom and fed into the target-actual value comparison, so that the activation is carried out depending on the previously determined theoretical changing behavior.

FIG. 2b shows the regulating loop. In this the line force and hence the bollard pull function as regulating variables. A control signal Y₃ to the drives 3 is produced by means of the target-actual value comparison. The adjustment performed on said control signal causes a change of the actual value Xᵢₛₜ that is currently to be detected of the line force and hence of the alignment with the target value Xₛₒₗₗ.

Predictively taking into account the influences of the ambient conditions on the motion of the tugboat 1, and hence also on the bollard pull, is additionally provided in FIGS. 2a and 2b.

The detecting device 11 for the detection of at least one variable at least indirectly influencing the motion of the ship and/or the bollard pull is provided for this. The device 11 is used for the detection of the wave height and/or wave direction for example. The device 11 is also coupled to the control and/or regulating device 10. The analysis of said variables is incorporated into the generation of the control variable Y₃ or of the control signal for the drive 3, so that the actual value again tracks the target value by activating the drive 3 or an actual value change is prevented by suitably activating the drives 3. In particular, the control devices 13 for influencing the direction of thrust and/or thrust force of the individual drive 3 are activated.

I.e., the second regulation concept is specifically overlaid onto the basic regulation here, wherein additionally the change with time Xᵢₛₜ(t) is determined from the variables S, which were determined by the device 11 for the detection of the ambient conditions causing the change of the bollard pull, and is fed into the target-actual value comparison.

FIGS. 3a and 3b show by way of example two embodiments of tugboats 1, in which the solution according to the invention is preferably used. The drive concepts described therein are particularly well suited to the method according to the invention owing to the rapid responsiveness thereof.

The tugboat 1 according to FIG. 3a comprises two controllable drives 3, 3. Said drives are disposed on both sides of the central longitudinal plane of the tugboat 1, and indeed in the region of one end thereof. A fin 17 is disposed on the opposite end. The fin 17 is provided with a roller 18. Said roller comprises a roller drive that is not illustrated here for rotating the roller about the longitudinal axis thereof.

In the present case, the two tugboat drives 3 are Voith-Schneider propellers. Instead of this, other types of drive would also be considered.

The watercraft 1 represented in FIG. 3b again comprises two controllable drives 3, 3. Said drives are implemented as rudder propellers in the present case.

Again a rotatable roller 18 according to the invention is provided at the end of the watercraft opposite the drives of the watercraft. As can be seen, said roller is disposed exactly vertically.

Said watercraft comprises a strong bar keel, on which the roller 18 is disposed on the incident flow end.

### REFERENCE CHARACTER LIST

1 tugboat
2 cargo vessel
3 drive
4 tow line
5 cable device
6 control device
7 bollard pull target value specification device
8 detecting device
9 external influencing factors; waves
10 control and/or regulating device
11 detecting device
12 comparator
13 control device drive
14 pivoting direction of the tugboat
15 control variable generator
17 fin
18 roller
Xᵢₛₜ actual value
Xₛₒₗₗ target value
ΔX deviation
Y₃ control variable
Z pulling connection
S variable, detected with device 11

1-17. (canceled)

18. A tugboat for assisting a cargo vessel, comprising:
at least one drive and a control device controlling said at least one drive;
at least one tow line for establishing a pulling connection between the cargo vessel and the tugboat;
at least one detecting device for detecting at least one variable directly or indirectly characterizing a bollard pull between the cargo vessel and the tugboat, said at least one detecting device including a device for detecting a variable describing a change of an ambient condition of the tugboat causing the bollard pull;
a controller connected to receive from said at least one detecting device the at least one variable characterizing the bollard pull, said controller being configured to form at least one control variable for activating said control device of said at least one drive for influencing one or both of a thrust force or a thrust direction of the tugboat; and
said controller including an analyzer configured to derive a theoretical changing behavior of an actual value of the bollard pull over time from variables describing a motion of the tugboat and/or variables describing the ambient condition of the tugboat under the influence of said variables and to provide the theoretical changing behavior of the actual value of the bollard pull over time to a comparison between a target value and an actual value.

19. The tugboat according to claim 18, wherein said controller is a closed-loop controller.

20. The tugboat according to claim 18, wherein said detecting device is a device selected from the group consisting of a force sensor and a torque sensor, and said detecting device is disposed in a region of a cable device guiding the tow line.

21. The tugboat according to claim 18, which further comprises a target value specification device for specifying a target value for the bollard pull to be set, and wherein:
said target value specification device is coupled to said controller; and
said controller includes a comparator configured to compare the target value with the actual value and a control variable generator configured to generate a control variable for activating the control device for changing the direction of thrust and/or a thrust force of an individual said drive.

22. The tugboat according to claim 21, wherein said at least one drive is one of at least two drives each being a Voith Schneider propeller.

23. The tugboat according to claim 18, wherein said at least one drive is one of at least two drives each being a Voith Schneider propeller.

24. The tugboat according to claim 23, wherein said at least one detecting device for the detection of a variable describing the ambient condition of the tugboat causing a change of the bollard pull is configured to detect a variable describing a motion of the tugboat and to detect a variable describing the ambient conditions of the tugboat.

25. The tugboat according to claim 24, wherein said at least one detecting device comprises at least one device selected from the group of devices consisting of:
a roll angle detecting device;
a course angle detecting device;
a course angle rate of change detecting device;
a course angle acceleration detecting device;
a roll angle acceleration detecting device;
a pitch angle detecting device;
a pitch angle acceleration detecting device;
a wave height detecting device;
a wave frequency detecting device; and
wave direction detecting device.

26. The tugboat according to claim 18, which further comprises a target value specification device for specifying a target value for the bollard pull to be set, and wherein:
said target value specification device is coupled to said controller; and
said controller includes a comparator configured to compare the target value with the actual value and a control variable generator configured to generate a control variable for activating the control device for changing the direction of thrust and/or a thrust force of an individual said drive; and
said at least one detecting device for the detection of a variable describing the ambient condition of the tugboat causing a change of the bollard pull is configured to detect a variable describing a motion of the tugboat and to detect a variable describing the ambient conditions of the tugboat.

27. The tugboat according to claim 18, wherein said controller is a controller for said at least one drive or is integrated therein.

28. A method for closed-loop control of a bollard pull between a cargo vessel and a tugboat, wherein the tugboat has at least one drive, a tow line for establishing a pulling connection to the cargo vessel and a controller or closed-loop controller, the method comprising:
in a first control concept, detecting an actual value of a variable at least indirectly characterizing the bollard pull in the pulling connection and, if the actual value exceeds and/or deviates from a predefined target value, activating the at least one drive of the tugboat for influencing one or both of a thrust force or a thrust direction of the tugboat; and
in a second control concept, detecting the actual value of the variable at least indirectly characterizing the bollard pull in the pulling connection and determining a change of the actual value occurring with a time lag, and, if the actual value deviates from the predefined target value, activating the at least one drive for influencing one or both of the thrust force or the thrust direction of the tugboat.

29. The method according to claim 28, wherein the second control concept is overlaid on the first control concept.

30. The method according to claim 29, which comprises predetermining the target value as a permissible maximum value for a line force on the tow line or a predefined average value that is to be achieved for the line force.

31. The method according to claim 29, which comprises determining at least one of the following variables:
a variable at least indirectly describing a motion of the tugboat;
a variable at least indirectly describing external ambient conditions of the tugboat;
and determining the change of the actual value occurring with a time lag as a function of at least one of the variables or derived the change of the actual value occurring with a time lag from at least one of the variables.

32. The method according to claim 28, which comprises predetermining the target value as a permissible maximum value for a line force on the tow line or a predefined average value that is to be achieved for the line force.

33. The method according to claim 32, which comprises determining at least one of the following variables:
a variable at least indirectly describing a motion of the tugboat;
a variable at least indirectly describing external ambient conditions of the tugboat;
and determining the change of the actual value occurring with a time lag as a function of at least one of the variables or derived the change of the actual value occurring with a time lag from at least one of the variables.

34. The method according to claim 33, which comprises detecting at least one variable selected from the following group of variables as a variable at least indirectly describing the motion of the tugboat:
a roll angle;
a course angle;
a course angle rate of change;
a course angle acceleration;
a roll angle acceleration;
a pitch angle; and
a pitch angle acceleration.

35. The method according to claim 33, which comprises detecting at least one variable selected from the following group of variables as a variable at least indirectly describing the external ambient conditions of the tugboat:
a wave height;
a wave frequency; and
a wave direction.

36. The method according to claim 28, wherein detecting the actual value of the variable at least indirectly characterizing the bollard pull in the pulling connection comprises detecting at least one of the variables:
a pulling force or line force; and
a torque on a winch of a cable device.

37. The method according to claim 28, which comprises detecting at least one of the following variables continuously or at predefined time intervals:
the actual value of a variable at least indirectly characterizing the bollard pull in the pulling connection;
a variable at least indirectly describing a motion of the tugboat; and
a variable at least indirectly describing external ambient conditions of the tugboat.
